(19) United States
(12) Patent Application Publication
(10) Pub. No.: US 2022/0184924 A1
(43) Pub. Date: Jun. 16, 2022

(54) Functional Composite Material Textile Structure and the Manufacturing Method Thereof

(71) Applicants: YU-CHENG HUANG, Kaohsiung (TW); YIN-TZU HSIEH, Kaohsiung (TW); KANG-HUNG CHEN, Changhua County (TW)

(72) Inventors: YU-CHENG HUANG, Kaohsiung (TW); YIN-TZU HSIEH, Kaohsiung (TW); KANG-HUNG CHEN, Changhua County (TW)

(21) Appl. No.: 17/120,053

(22) Filed: Dec. 11, 2020

(51) Int. Cl. B32B 15/14; B32B 7/12; B32B 3/10; B32B 5/02; B32B 5/24; B32B 15/08

(52) U.S. Cl. CPC B32B 15/14; B32B 7/12; B32B 3/10; B32B 5/024; B32B 5/24; B32B 15/08; B32B 2437/00; B32B 2307/21; B32B 2255/26; B32B 2307/728; B32B 2307/7265; B32B 2307/724; B32B 2307/748; B32B 2255/02

(57) ABSTRACT

The present invention relates to a composite material textile structure and the manufacturing method thereof. The antistatic protective metal layer can be stably adhered to the fabric layer. The adhesive layer is a moisture cured hot melt adhesive. The hot melt adhesive will become sticky after heating and will be cured by moisture. The waterproof and breathable wear resistant thin film layer is a hydrophilic film material. The inner surface of the waterproof and breathable film layer is attached to the lower surface of the metal layer via the adhesive layer. The waterproof and breathable film layer can be fixed on the metal layer to offer wear and scratch resistance. The printed layer includes a plurality of protruding printed patterns and is configured on the outer surface of the waterproof and breathable wear resistant thin film layer.

### BACKGROUND OF INVENTION

### 1. Field of the Invention

The present invention relates generally to a composite material textile structure and the manufacturing method thereof, and more particularly to a unique functional composite material textile structure specially manufactured by attaching a film layer on an ultra-thin metal layer to offer antistatic, antimicrobial, breathable and highly scratch-resistant effects.

### 2. Description of Related Art

Along with the rapid development and evolution of technology, the textile industry must keep up to date with new technological trends. Textile consumers are becoming more and more demanding and various kinds of functional textile have been developed. The fast fashion trend together with the spread of infectious diseases in recent years entail more functions for textile products, including antistatic, antimicrobial, waterproof, breathable, comfortable and scratch resistant effects. Such functions have become significant considerations when consumers buy textile products. In the early stage, antistatic fabric products are made by applying electrical conductive ink on the fabric by means of single-surface screen printing, and carbon powder is adhered to the surface of the fabric for conductivity between both sides, forming a carbon-base fabric, and then, the fabric is laminated with a PVC film containing an antistatic agent to produce a textile product with antistatic property. However, as the carbon powder may easily contaminate the surface, during the lamination process, the carbon powder may easily be transmitted to other machine parts, causing higher defect rate and poor quality. As such, some manufacturers soak fabric directly into a solution containing antistatic material, and after absorbing sufficient antistatic material, the fabric is adhered to a PVC film, so that the fabric has an antistatic ability. However, it is hard for the antistatic material to be evenly and completely absorbed into the fabric, and some areas may have lower antistatic ability.

In recent years, due to wide spread of infectious diseases, consumers are gradually paying more attention to the antimicrobial effect of textiles. An antimicrobial textile product can prevent external bacteria from spreading or infesting on the textile, and can effectively reduce the risk of infection to cause colds, food poisoning, or other human diseases. Therefore, the application of antimicrobial textile is becoming more and more common. A conventional antimicrobial textile product is usually produced by adding silver ion antimicrobial fibers into the textile so that silver ions or nano silver atoms infiltrate the whole fibers to generate an antimicrobial effect. However, when touched by skin, the silver ions or nano silver atoms may enter the human body to cause heavy metal residue. Over a long period of time, it may cause serious health problems. Therefore, some manufacturers use copper-containing antimicrobial fiber textile for an antimicrobial effect. Such textile products are made by applying copper compound on the surface of the fiber or soaking the fiber into copper-containing chemical antimicrobial agent. However, when the textile product is washed, the internal silver ions, nano silver atoms, or copper ions may be dissolved and disappear, resulting in loss of the antimicrobial effect.

Therefore, some manufacturers use drying process to remove water vapor from the fabric, and make the fiber surface coarser, and then, use high pressure plasma to increase the coefficient of friction. After the fabric is prepared as above, an aluminum film layer is plated onto the surface of the fabric by means of vacuum plating to enhance the bonding of the aluminum film on the fabric. However, as the aluminum film layer is directly attached on the rough surface of the fabric by means of vacuum sputtering or evaporation, the aluminum film layer may directly contact other objects or the skin of the user, resulting in wear or flaking of the aluminum film layer; in view of this, how to manufacture a highly antistatic and antimicrobial, waterproof, breathable, comfortable and scratch resistant textile product has become a major topic for current fiber textile manufacturers.

### SUMMARY OF THE INVENTION

In view of the above technical problems and based on years of experience in the research and development as well as practical production, the inventor of the present invention has made numerous improvements before proposing the present invention, aiming to enhance the production processes of the present invention and solve the drawbacks of the prior art.

The main object of the present invention is to provide a functional composite material textile structure and the manufacturing method thereof, effectively bonding a metal layer and a waterproof and breathable wear resistant thin film layer to the fabric through improved techniques to offer antistatic and antimicrobial effects.

Another object of the present invention is to provide a functional composite material textile structure and the manufacturing method thereof, bonding a waterproof and breathable wear resistant thin film layer to a metal layer through an adhesive layer having moisture cured hot melt adhesives so that the bonding is tight and stable, and the laminated structure has superior wear resistance without falling apart.

A further object of the present invention is to provide a functional composite material textile structure and the manufacturing method thereof with configuration of a printed layer having a plurality of protruding printed patterns attached to the waterproof and breathable wear resistant thin film layer, so as to offer great comfort when touched by the skin of the user.

To achieve the above objects, the functional composite material textile structure and the manufacturing method thereof disclosed in the present invention includes a surface fabric layer, an antistatic protective metal layer, an adhesive layer, a waterproof and breathable wear resistant thin film layer and a printed layer, wherein, the antistatic protective metal layer mainly includes an upper surface and a lower surface, the upper surface being adhered to the fabric layer, the adhesive layer is a moisture cured hot melt adhesive, which will become sticky after heating and will be cured by moisture, the waterproof and breathable wear resistant thin film layer is a hydrophilic film material, the inner surface of the waterproof and breathable film layer is attached to the lower surface of the metal layer via the adhesive layer, the printed layer includes a plurality of protruding printed patterns and is configured on the outer surface of the waterproof and breathable wear resistant thin film layer; normally, the material of the antistatic protective metal layer is any of aluminum, gold, silver, copper, zinc, cobalt, iron, tin, peqieen, or platinum, or their alloys, which has low hardness. When contacting objects with high hardness, or being frequently scratched by the user, the antistatic protective metal layer will easily wear out or fall off. Also, as a metal material is normally made up of atom stack structures, when the thin metal film is attached to an adhesive, the bonding is usually not stable and the film may flake easily. Therefore, the adhesive layer uses a moisture cured hot melt adhesive as the main adhesive material. It is an isocyanate terminated prepolymer made from isocyanate and polybasic alcohol compounds through polymerization reaction. As a solid compound without solvent, when cured by moisture, it will reach a very high adhesion strength and will meet the requirement for adhering metal. Meanwhile, it has such advantages as easy application, good curing condition, high adhesion strength, heat resistance, chemical resistance, durability etc. Using the moisture cured hot melt adhesive, the waterproof and breathable wear resistant thin film layer can be tightly and stably bonded on the antistatic protective metal layer, offering very strong adhesion effect, so that the waterproof and breathable wear resistant thin film layer can effectively protect the antistatic protective metal layer and avoid separation or flaking due to scratches by external objects of high hardness, and maintain the antistatic protection and waterproof and breathable effects for a long period of time.

Preferably, the material of the adhesive layer is any of acrylic adhesive, hot melt adhesive, epoxy or their combinations.

Preferably, the material of the antistatic protective metal layer is any of aluminum, gold, silver, copper, zinc, cobalt, nickel, iron, tin, peqieen, platinum, or their alloys.

Preferably, the material of the hydrophilic film is any of PU film material, TPEE film material, or their combinations.

Thus, based on the present invention, the functional composite material textile structure and the manufacturing method thereof have multiple properties, being highly antistatic and antimicrobial, waterproof, and breathable. Detailed descriptions are provided below:
(1) Offering highly antistatic and antimicrobial effects: based on the antistatic property of the antistatic protective metal layer bonded with a waterproof and breathable wear resistant thin film layer for an antimicrobial effect, the overall functional composite material textile structure becomes a highly antistatic and antimicrobial structure.
(2) Having very good waterproof and breathable property: offered by the waterproof and breathable wear resistant thin film layer attached to the antistatic protective metal layer via the adhesive layer. As the waterproof and breathable wear resistant thin film layer is mainly made of hydrophilic film material (such as PU or TPEE), it has very good waterproof and breathable property. Water vapor inside the fabric can be discharged through the breathable thin film, but water drops can not enter from the outside.
(3) Comfortable experience for the user: the waterproof and breathable wear resistant thin film is mainly made of hydrophilic materials like PU film material, TPEE film material etc, which may cause uncomfortable sticky feeling when directly touched by the skin. Therefore, the present invention provides an additional layer having a plurality of protruding printed patterns to be configured on the outer surface of the waterproof and breathable wear resistant thin film layer, so as to offer a unique comfortable feeling when touched.
(4) Unique super wear resistant structure: through a special process, the present invention attaches the waterproof and breathable wear resistant thin film layer to an antistatic protective metal layer via an adhesive layer having moisture cured hot melt adhesive, so that the easily worn-out metal can be protected by the waterproof and breathable wear resistant thin film layer, thus significantly reducing the wear of the antistatic protective metal layer, providing a functional composite material textile structure with superior wear resistance.

### BRIEF DESCRIPTION OF THE DRAWINGS

FIG. 1 is a schematic view of the functional composite material textile structure according to the invention.

FIG. 2 is a sectional view of the functional composite material textile structure according to the invention.

FIG. 3 is a layer-by-layer structural view of the functional composite material textile structure according to the invention.

### DETAILED DESCRIPTION OF THE INVENTION

For better understanding of the objects, technical solutions and advantages of the present invention, further detailed descriptions are provided below with reference to a preferred embodiment of the invention. It is to be noted, however, that the embodiment is not intending to limit the scope of the invention. Any modification, equivalent substitution, and improvement without departing from the spirit and principle of this invention should be covered in the protection scope of the invention. It is apparent that those skilled in the art can make various modifications and variations to the present invention using common technical knowledge and means in the related field.

The technical features of the present invention are described below based on a preferred embodiment and with reference to the accompanying drawings to provide an insight into the present invention.

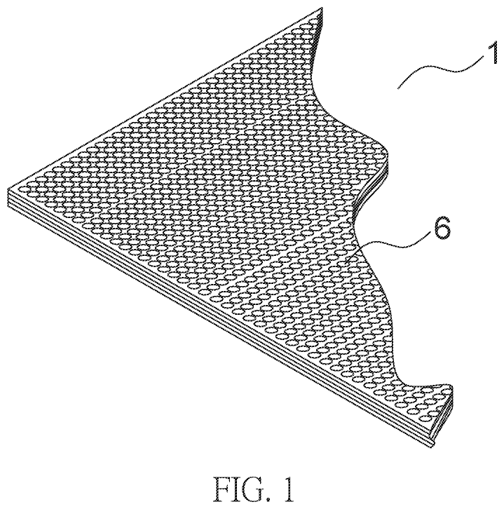

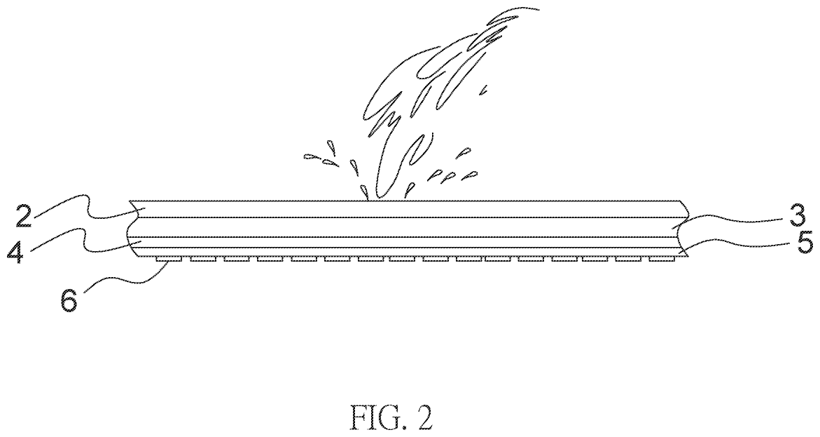

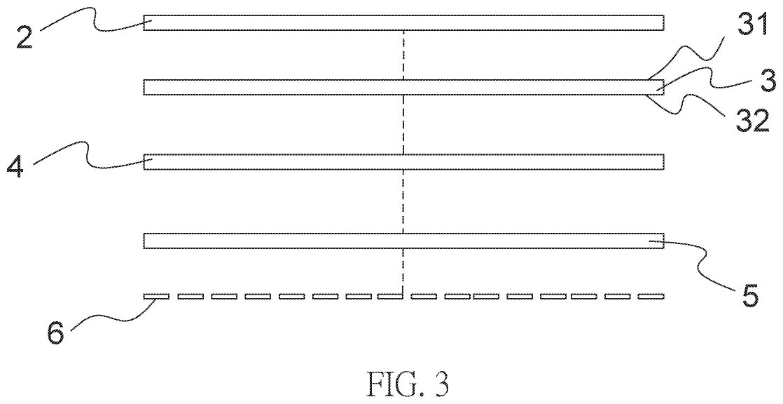

The present invention is a functional composite material textile structure and the manufacturing method thereof. FIGS. 1 to 3 respectively show a schematic view, a sectional view, and a layer-by-layer structural view of the functional composite material textile structure and the manufacturing method thereof according to the invention. It is made up of a surface fabric layer (2), an antistatic protective metal layer (3), an adhesive layer (4), a waterproof and breathable wear resistant thin film layer (5) and a printed layer (6). The surface fabric layer (2) is a fabric structure. The antistatic protective metal layer (3) is an aluminum metal film layer, including an upper surface (31) and a lower surface (32) relative to each other. It is adhered to a release film by means of evaporation, and then, through a moisture cured hot melt adhesive, its upper surface (31) is attached to a lateral surface of the surface fabric layer (2). Then, the lower surface (32) of the antistatic protective metal layer (3) is attached to a waterproof and breathable wear resistant thin film layer (5) via the adhesive layer (4). The adhesive layer (4) is a moisture cured hot melt adhesive. The hot melt adhesive will become sticky after heating and will be cured by moisture, so that it can tightly bond the antistatic protective metal layer (3) and the waterproof and breathable wear resistant thin film layer (5) together. The waterproof and breathable wear resistant thin film layer (5) is a hydrophilic film material. The hydrophilic film material is a PU film material or TPEE film material, having waterproof and breathable properties, and capable of preventing bacteria or virus from invading the fabric. The printed layer (6) includes a plurality of protruding printed patterns and is configured on the outer surface of waterproof and breathable wear resistant thin film layer (5). When the user's skin touches the textile, it will directly touch the plurality of protruding printed patterns, and the user will feel comfortable. Hence, the present invention is a functional composite material textile structure having antistatic, antimicrobial, waterproof, breathable, comfortable and scratch resistant effects.

A functional composite material textile structure and the manufacturing method thereof uses a weaving equipment to form a polyester fiber and a regenerated polyester fiber into a fabric, which is dyed and washed using a dyeing and finishing equipment, then the surface fabric layer (2) after dyeing and finishing is fed into a set-stretching equipment and added with water repellent agent for the heating process to form a surface fabric layer (2); then, a metal evaporator forms an antistatic protective metal layer (3) on a plane release film using an evaporation equipment, so that said antistatic protective metal layer (3) comprises a metal surface and a release film; then, a laminating equipment that is configured behind said set-stretching equipment and said evaporation equipment to attach the surface fabric layer (2) to the metal surface of said antistatic protective metal layer (3) with an adhesive layer (4) so that said release film is detached from said metal surface to form a metal evaporated fabric, and said metal evaporated fabric is attached with a waterproof and breathable wear resistant thin film layer (5) to form a metal evaporated protective fabric, then the outer layer of said metal evaporated protective fabric is attached with a printed layer (6) so as to form a functional composite material textile structure (1).

Although the invention has been explained in relation to its preferred embodiment, it is to be understood that many other possible modifications and variations can be made without departing from the spirit and scope of the invention as hereinafter claimed.

To summarize, the embodiment of the present invention can truly achieve the expected effects. The detailed structure disclosed in the invention are not seen in similar products, or disclosed before the application of this invention. As such, according to the provisions and requirements of the Patent Law, an application for patent is submitted herein. Your audit and approval will be highly appreciated.

1. A functional composite material textile structure, including:
a surface fabric layer; an antistatic protective metal layer, which includes an upper surface and a lower surface relative to each other, wherein, the upper surface is adhered to the fabric layer; an adhesive layer, said adhesive layer being a moisture cured hot melt adhesive, which will become sticky after heating and will be cured by moisture;
a waterproof and breathable wear resistant thin film layer, being a hydrophilic film material, the inner surface of the waterproof and breathable film layer being attached to the lower surface of the metal layer via the adhesive layer; and a printed layer, including a plurality of protruding printed patterns and configured on the outer surface of the waterproof and breathable wear resistant thin film layer.

2. The functional composite material textile structure defined in claim 1, wherein the material of said adhesive layer is any of acrylic adhesive, hot melt adhesive, epoxy, or their combinations.

3. The functional composite material textile structure defined in claim 1, wherein the material of said antistatic protective metal layer is any of aluminum, gold, silver, copper, zinc, cobalt, nickel, iron, tin, peqieen, platinum or their alloys.

4. The functional composite material textile structure defined in claim 1, wherein the material of said hydrophilic film is any of PU film material, TPEE film material, or their combinations.

5. A functional composite material textile structure and the manufacturing method thereof, first uses a weaving equipment to form a polyester fiber and a regenerated polyester fiber into a fabric, which is dyed and washed using a dyeing and finishing equipment, then the surface fabric layer after dyeing and finishing is fed into a set-stretching equipment and added with water repellent agent for the heating process to form a surface fabric layer; then, a metal evaporator forms an antistatic protective metal layer on a plane release film using an evaporation equipment, so that said antistatic protective metal layer comprises a metal surface and a release film; then, a laminating equipment that is configured behind said set-stretching equipment and said evaporation equipment to attach the surface fabric layer to the metal surface of said antistatic protective metal layer with an adhesive layer so that said release film is detached from said metal surface to form a metal evaporated fabric, and said metal evaporated fabric is attached with a waterproof and breathable wear resistant thin film layer to form a metal evaporated protective fabric, then the outer layer of said metal evaporated protective fabric is attached with a printed layer so as to form a functional composite material textile structure.
